(19) United States
(12) Patent Application Publication
(10) Pub. No.: US 2007/0144646 A1
(43) Pub. Date: Jun. 28, 2007

(54) Tire traction enhancement system and method of use

(76) Inventors: Jorge A. Mancia, Los Angeles, CA (US); Mauricio Villalta, Bethlehem, GA (US)

Correspondence Address: Galasso & Associates, LP, P.O. Box 26503, Austin, TX, 78755-0503, US

(21) Appl. No.: 11/508,711

(22) Filed: Aug. 23, 2006

Related U.S. Application Data
(60) Provisional application No. 60/753,874, filed on Dec. 23, 2005.

(51) Int. Cl. B60C 11/00

(52) U.S. Cl. 152/210

(57) ABSTRACT

A tire traction enhancement system and method of use are provided. In one form, a tire traction enhancement system includes a standard vehicle tire including perforations along the standard vehicle tire tread. The tire traction enhancement system further includes a first annular inner tube running substantially the inner circumference of the standard vehicle tire and a second annular inner tube between the first annular inner tube and the outer circumference of the standard vehicle tire. The second annular inner tube further includes a plurality of studs fastened to the outer circumference of the second inner tube and fastened to the perforations along the standard vehicle tire tread.

### CROSS REFERENCE TO RELATED APPLICATIONS

This application claims priority to co-pending U.S. Provisional Patent Application having Ser. No. 60/753874 filed Dec. 23, 2005 entitled “Clowed The Ice Breaker Tire”, having a common applicant herewith.

### FIELD OF THE DISCLOSURE

The invention generally relates to vehicle tires, and more particularly to a tire traction enhancement system and method of use.

### BACKGROUND

The United States of America has been accurately referred to as a nation on wheels, as its countryside, suburbs, and cities are crisscrossed with roads and highways. Vehicles are an integral part of American lives, providing the primary means of transportation for both business and pleasure for the vast majority of the population. The need for transportation continues year-round, regardless of the weather. Unfortunately, during icy weather, driving becomes treacherous, even deadly. A variety of traction enhancement means currently exists, such as snow tires and chains. The snow tires do not provide the ride and handling of standard vehicle tires, and greatly inconvenience the user by requiring them to change out their tires. Additionally, the tires are still merely rubber, providing some additional traction, but not enough in many circumstances. Chains provide greater traction, but are inconvenient, requiring the user to spend substantial time placing the chains on the tire, and then later removing them. In addition to inconvenience, the chains may pose a safety risk by requiring the user to be on the side of the road manipulating the chains during icy conditions. What is needed is a tire traction enhancement system that is completely integrated into a standard vehicle tire.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a front perspective view of a tire traction enhancement system in accordance with one aspect of the invention; and

FIG. 2 illustrates a side perspective view of a tire traction enhancement system in accordance with one aspect of the invention.

### DESCRIPTION

A tire traction enhancement system and method of use are provided. In one form, a tire traction enhancement system includes a standard vehicle tire with an inner circumference, an outer circumference, standard vehicle tire side walls, standard vehicle tire tread, and perforations along the standard vehicle tire tread. The tire traction enhancement system further includes a first annular inner tube and a stud extension and retraction system operable to extend and retract the plurality of studs through the perforations. The tire traction enhancement system further includes a second annular inner tube between the first inner tube and the outer tire wall, and a circular wire structure operable to assist in the extension and retraction of the studs. The tire traction enhancement system may be triggered manually by the user, or automatically by sensors slipping wheel slippage.

According to another aspect of the invention, a tire traction enhancement system is provided and includes a standard vehicle tire including an inner circumference, an outer circumference, standard vehicle tire side walls, standard vehicle tire tread, and perforations along the standard vehicle tire tread. The tire traction enhancement further includes a first annular inner tube running along the inner circumference of the tire and a second annular inner tube running between the first annular inner tube and the outer circumference of the tire. The tire traction enhancement system further includes a plurality of studs fastened to the outer circumference of the second annular inner tube and fastened to the perforations along the tire tread. In one embodiment, the studs comprise a durable, non-corrosive material which can accept and retain coloring.

According to a further aspect of the invention, a tire traction enhancement system is provided and includes a standard vehicle tire including an inner circumference, an outer circumference, an inner diameter, an outer diameter, an inner cavity, standard vehicle tire side walls, standard vehicle tire tread, and perforations along the standard vehicle tire tread. The tire traction enhancement system further includes a first annular inner tube running substantially along the inside of the inner circumference of the standard vehicle tire, a second annular inner tube running substantially outside the outer circumference of the first inner tube and inside the outer circumference of the standard vehicle tire, and a plurality of studs fastened to the outer circumference of the second inner tube and fastened to the perforations along the standard vehicle tire tread. The second inner tube further includes a circular wire structure fastened to the second annular inner tube and plurality of studs, operable to enable the extension and retraction of the studs through the perforations along the standard vehicle tire tread. The studs are extended by inflating the second annular inner tube and retracted by deflating the second annular inner tube.

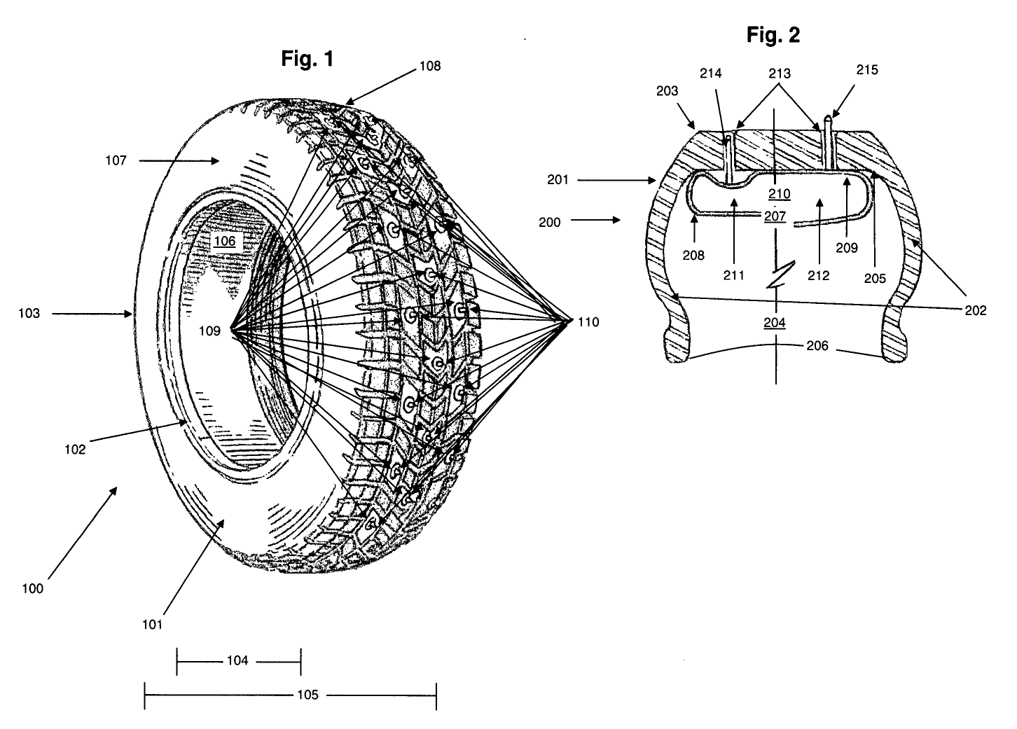

FIG. 1 illustrates a front perspective view of a tire traction enhancement system in accordance with one aspect of the present invention. A tire traction enhancement system is illustrated generally at 100 and includes a standard vehicle tire 101. Standard vehicle tire 101 includes an inner circumference 102, an outer circumference 103, an inner diameter 104, an outer diameter 105, standard vehicle tire sidewall 107, and standard vehicle tire tread 108. Inner diameter 104 may be provided in a variety of diameters and in one embodiment is fifteen (15) inches. Outer diameter 105 may be provided in a variety of diameters and in one embodiment is twenty-five (25) inches. Standard vehicle tire sidewall 107 represents the surface of standard vehicle tire contiguously attached to inner circumference 102 and outer circumference 103. Standard vehicle tire tread 108 runs substantially along outer circumference 103 and represents the surface of standard vehicle tire 101 contacting the ground (not expressly shown) during use, providing traction to the vehicle (not expressly shown). Standard vehicle tire 101 further includes inner cavity 106 running the length of inner circumference 103, allowing standard vehicle tire 101 to be fitted to a standard vehicle tire rim (not expressly shown). Tire traction enhancement system 100 further includes perforations 109 disposed along standard vehicle tire tread 108 and a plurality of studs 110 attached to perforation 109. Tire traction enhancement system 100 is activated by inflation of an annular inner tube (not expressly shown) disposed along outer circumference 103 and internal to tire 101. Studs 110 attached to the annular inner tube (not expressly shown) pass through perforations 109 to extend past standard vehicle tire tread 108. When in this extended position, studs 110 will grip a slippery surface such as ice and provide greater traction than tire tread 108 by itself. When studs 110 are in a retracted position, studs 110 do not extend past perforations 109, allowing standard vehicle tire tread 108 to perform normally. Perforations 109 may be fitted with a seal (not expressly shown) operable to prevent solid and liquid debris from entering standard vehicle tire 101.

Tire traction enhancement system 100 may be provided in a variety of materials and in one embodiment, standard vehicle tire 101 comprises rubber and studs 110 comprise a durable metal. Standard vehicle tire tread 108 may be provided in a variety of treads and in one embodiment standard vehicle tire tread 108 is a traction-enhancing winter tire tread. Standard vehicle tire 101 may be provided in various embodiments and in one embodiment is a standard tire for use with a standard inner tube. In another embodiment, standard vehicle tire is provided in a run-flat tire. Studs 110 may be provided in a variety of materials including, but not limited to, steel, stainless steel, plastic, carbon fiber, and various alloys.

During use, a user equips his or her vehicle with four tires containing tire traction enhancement system 100. During non-icy conditions, the user will drive with studs 110 in a retracted position. With studs retracted, standard vehicle tire 101 performs normally, possessing all of the attributes of a comparable tire without traction enhancement system 100. Tire traction enhancement system 100 may be activated by a variety of methods and in one embodiment, tire traction enhancement system 100 is activated manually. When the user anticipates icy conditions, the user brings the vehicle (not expressly shown) to a complete stop, and inserts air into a second annular inner tube (not expressly shown) attached to studs 110 and running substantially along outer circumference 103 on the interior of standard vehicle tire 101.

In another embodiment, tire traction enhancement apparatus 100 is activated automatically in response to a sensor detecting a slippage of standard vehicle tire 101 on an icy surface and activating tire traction enhancement apparatus 100 causing an extension of studs 110 past standard tire tread 108, enabling standard vehicle tire 101 to better grip the icy surface and providing an additional amount of safety. In another embodiment, the user activates tire traction enhancement system 100 with a switch mounted inside the vehicle causing an extension of studs 110 past standard tire tread 108, enabling standard vehicle tire 101 to better grip the icy surface and providing an additional amount of safety. Studs 110 may be extended to a variety of depths and in one embodiment extends one (1) inch past standard fire tread 108. In one embodiment, the user may adjust the distance studs 110 extend past standard tire tread 108 by adjusting the amount of air inserted into the second annular inner tube (not expressly shown). The ability to activate tire traction enhancement apparatus 100 on the go provides much greater safety to the user than having to stop and put on tire chains, and provides greater convenience than having to switch the user's standard tires for snow tires.

FIG. 2 illustrates a side perspective view of a tire traction enhancement system in accordance with one aspect of the present invention. A tire traction enhancement system is illustrated generally at 200. Tire traction enhancement system 200 includes standard vehicle tire 201. Standard vehicle tire 201 includes standard vehicle tire sidewalls 202 disposed on an outer side of standard vehicle tire 201, standard vehicle tire tread 203 disposed along the exterior of standard vehicle tire outer circumference 205, and standard vehicle tire cavity 204, positioned central to standard vehicle tire outer circumference 205, standard vehicle tire inner circumference 206 and standard vehicle tire sidewalls 202. Tire traction enhancement system 200 further includes a first annular inner tube (not expressly shown) disposed internal to standard vehicle tire cavity 204 and along the outer surface of standard vehicle tire inner circumference 206. Disposed along the inner surface of standard vehicle tire inner circumference is a cavity (not expressly shown) which allows standard vehicle tire 201 to be fitted to a standard vehicle tire rim (not expressly shown). Standard vehicle tire cavity 204 includes second annular inner tube 207 disposed between the outer circumference of a first annular inner tube (not expressly shown) and standard vehicle tire outer circumference 205. Second annular inner tube 207 includes second annular inner tube outer wall 208, second annular inner tube inner wall 209, and second annular inner tube cavity 210. Second annular inner tube 207 may be inflated and deflated independently of the first annular inner tube (not expressly shown). The first annular inner tube (not expressly shown) provides normal operation of the vehicle (not expressly shown) when inflated.

Second annular inner tube 207 may be provided in a variety of positions and is generally illustrated in a deflated position at 211 and in an inflated position at 212. Second annular inner tube 207 provides normal operation of standard vehicle tire 201 when in deflated position 211. A stud coupled to deflated annular inner tube 211 in a retracted position is illustrated generally at 214. Second annular inner tube 207 provides enhanced traction for standard vehicle tire 201 when second annular tube cavity 210 is filled with air, causing stud 215 to extend through perforations 213 past standard vehicle tire tread 203, generally illustrated at 215. Extended stud 215 is operable to grip a slippery surface such as ice, providing enhanced traction.

During use, a user equips his or her vehicle with tires containing tire traction enhancement system 200. During normal non-icy driving conditions, the user will operate the vehicle with second annular inner tube 207 in deflated position 211, causing the studs to be in a retracted position, illustrated generally at 214. Retracted studs 214 provide full normal operation of standard vehicle tire 201, including all normal handling and ride comfort attributes of any vehicle tire. Additionally, perforations 213 prevent liquid or solid matter from entering standard vehicle tire 201. When the user encounters icy conditions, the user will cause an inflation of second annular inner tube 207, expanding second annular inner tube cavity 210 and causing the stud 215 to be in an extended position, protruding through perforation 213 and past standard vehicle tire tread 203. The user now has a measure of additional traction on an icy surface without having to change tires or add snow chains to standard vehicle tire 201. Tire traction enhancement system may be use with a variety of vehicles including, but not limited to, cars, trucks, motorcycles, buses, vans, tractor-trailers, and airplanes.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

What is claimed is:

1. A tire traction enhancement system comprising:
a standard vehicle tire including an inner circumference, an outer circumference, standard vehicle tire side walls, standard vehicle tire tread, and perforations along the standard vehicle tire tread;
a first annular inner tube running substantially along the inside inner circumference of the standard vehicle tire; and
a stud extension and retraction system, operable to extend and retract a plurality of studs through the perorations along the standard vehicle tire tread.

2. The tire traction enhancement system of claim 1, wherein the stud extension and retraction system further comprises a second annular inner tube running substantially between the outer circumference of the first annular inner tube and the outer circumference of the standard vehicle tire.

3. The tire traction enhancement system of claim 1, wherein the stud extension and retraction system further comprises a plurality of studs fastened to the second annular inner tube and fastened to the perforations along the standard vehicle tire tread.

4. The tire traction enhancement system of claim 2, wherein the stud extension and retraction system further comprises a circular wire structure fastened to the second annular inner tube and operable to guide the studs through the perforations during an extension or retraction of the studs.

5. The system of claim 2, wherein the tire traction enhancement system further includes the second annular inner tube deflated during normal use, operable to maintain the studs in a retracted position.

6. The system of claim 2, wherein the tire traction enhancement system further includes the second annular inner tube inflated during normal use, operable to maintain the studs in an extended position.

7. The tire traction enhancement system of claim 2, wherein the stud extension and retraction system may be activated by manually inflating the second annular inner tube.

8. The tire traction enhancement system of claim 2, wherein the stud extension and retraction system may be activated by automatically inflating the second annular inner tube by activating a switch inside the vehicle.

9. The tire traction enhancement system of claim 2, wherein the stud extension and retraction system may be activated by automatically inflating the second annular inner tube in response to a sensor detecting wheel slippage.

10. The tire traction enhancement system of claim 2, wherein the stud extension and retraction system may extend the studs to a plurality of positions.

11. A tire traction enhancement system comprising:
a standard vehicle tire including an inner circumference, an outer circumference, standard vehicle tire side walls, standard vehicle tire tread, and perforations along the standard vehicle tire tread;
a first annular inner tube running substantially outside the inner circumference of the standard vehicle tire;
a second annular inner tube running substantially outside the outer circumference of the first annular inner tube and inside the outer circumference of the standard vehicle tire; and
a plurality of studs fastened to the outer circumference of the second annular inner tube and fastened to the perforations along the standard vehicle tire tread.

12. The tire traction enhancement system of claim 11, wherein the standard vehicle tire tread comprises a traction enhancing tire tread.

13. The tire traction enhancement system of claim 11, wherein the studs comprise a durable metal.

14. The tire traction enhancement system of claim 11, wherein the studs comprise a non-corrosive material.

15. The tire traction enhancement system of claim 11, wherein the studs can accept and retain coloring.

16. The tire traction enhancement system of claim 11, wherein the studs are stored in a manner to prevent puncture of the second annular inner tube when stored in a retracted position.

17. The tire traction enhancement system of claim 11, wherein the perforations further comprise a seal, operable to prevent liquids or solids from entering the tire while the studs are in a retracted or extended position.

18. A tire traction enhancement system comprising:
a standard vehicle tire including an inner circumference, an outer circumference, an inner diameter, an outer diameter, an inner cavity, standard vehicle tire side walls, standard vehicle tire tread, and perforations along the standard vehicle tire tread;
a first annular inner tube running substantially along the inside of the inner circumference of the standard vehicle tire;
a second annular inner tube running substantially outside the outer circumference of the first inner tube and inside the outer circumference of the standard vehicle tire; and
a plurality of studs fastened to the outer circumference of the second inner tube and fastened to the perforations along the standard vehicle tire tread.

19. The tire traction enhancement system of claim 18, wherein the second inner tube further includes a circular wire structure fastened to the second annular inner tube and plurality of studs, operable to enable the extension and retraction of the studs through the perforations along the standard vehicle tire tread.

20. The tire traction enhancement system of claim 18, wherein an inflation of the second annular inner tube is operable to provide an extension of the plurality of studs outside the surface of the standard vehicle tire tread, and a deflation of the second annular inner tube is operable to provide a retraction of the plurality of studs within the surface of the standard vehicle tire tread.
